(19) United States
(12) Patent Application Publication
(10) Pub. No.: US 2026/0105212 A1
(43) Pub. Date: Apr. 16, 2026

(54) SYSTEM FOR MANAGING BATTERY CELL DATA AND METHOD OF MANAGING BATTERY CELL DATA USING THE SAME

(71) Applicant: SAMSUNG SDI CO., LTD., Yongin-si (KR)

(72) Inventors: Joonseek KIM, Yongin-si (KR); Jaemoon LEE, Yongin-si (KR)

(21) Appl. No.: 19/347,879

(22) Filed: Oct. 2, 2025

(30) Foreign Application Priority Data
Oct. 16, 2024 (KR) 10-2024-0141621

(51) Int. Cl. G06F 30/20; G01R 31/367; G01R 31/396; G06F 111/20; G06F 119/02

(52) U.S. Cl. CPC G06F 30/20; G01R 31/367; G01R 31/396; G06F 2111/20; G06F 2119/02

(57) ABSTRACT

A system for managing battery cell data, the system including a data management unit configured to manage design and process data of a battery cell, a grade evaluator to grade evaluate the battery cell, and an ID associator to manage a design ID and an evaluation ID of the battery cell by associating the design ID and the evaluation ID.

### CROSS-REFERENCE TO RELATED APPLICATION

The present application claims the benefit of priority to Korean Patent Application No. 10-2024-0141621, filed on Oct. 16, 2024, in the Korean Intellectual Property Office, the entire disclosure of which is incorporated herein by reference.

### BACKGROUND

### 1. Field

The present disclosure relates to a system for managing battery cell data and a method of managing battery cell data using the same.

### 2. Description of the Related Art

A conventional technology has a problem in that there is a confusion of information in a process aspect and a system aspect because big data related to a design, a process, and evaluation are not associated and used.

Furthermore, according to a conventional technology, in the evaluation of a battery cell, there is a problem in that it is difficult to specify a charging or discharging pattern condition based on data that have not been standardized and have a continuous characteristic.

### SUMMARY

Embodiments include a system for managing battery cell data, the system including a data management unit configured to manage design and process data of a battery cell, a grade evaluator to grade evaluate the battery cell, and an ID associator to manage a design ID and an evaluation ID of the battery cell by associating the design ID and the evaluation ID.

The data management unit may be connected to a design database, a process condition database, and a material-physical property database, the data management unit being configured to perform input and output of data corresponding to the design ID.

The grade evaluator may be connected to a reliability database and a stability database and performs input and output of data corresponding to the evaluation ID.

The ID associator may manage the design ID generated in a design simulation and management way and the evaluation ID generated in a test data management way by associating the design ID and the evaluation ID.

The ID associator may manage design, process, and grade evaluation data as key values of the design ID and the evaluation ID.

The grade evaluator may determine whether a grade of the battery cell is a normal grade including ideal data and is an evaluation grade of a preset grade or less based on the grade evaluation, and may classify a cause analysis-required point, resulting in a classification.

The grade evaluator may provide feedback information to at least one of a design data manager and a process data manager that are included in the data management unit, based on results of the classification of the cause analysis-required point.

The design data manager and the process data manager may each assign item importance to a data item that is a target to be managed.

The design data manager may derive a design improvement proposal by considering the item importance when receiving the feedback information.

The grade evaluator may include an evaluation pattern writer to write an evaluation pattern, an evaluation scenario writer to write an evaluation scenario by considering the evaluation pattern, a scenario data extraction unit configured to extract a scenario data for the evaluation pattern through a continued evaluation progress, and a data visualizer to construct a visualization graph by retrieving summary data based on an evaluation item.

The evaluation pattern writer may designate pattern summary data to each type of pattern.

Embodiments include a method of managing battery cell data, the method including constructing, by a system for managing battery cell data, a management system for design data, process data, and evaluation data, performing, by the system for managing battery cell data, grade evaluation on a battery cell, and deriving, by the system for managing battery cell data, an improved design proposal through feedback on results of the grade evaluation.

The constructing may include generating a design ID of the battery cell in a design simulation and management way, generating an evaluation ID of the battery cell in a test data management way, and managing the design ID and the evaluation ID by associating the design ID and the evaluation ID.

The constructing may include managing design data, process data, and evaluation data as key values of the design ID and the evaluation ID.

The constructing may include managing design data stored in a design database, a process condition database, and a material-physical property database and evaluation data that are stored in a reliability database and a stability database.

The performing may include defining summary data of raw data based on continued evaluations and writing an evaluation scenario.

The performing may include designating a summary data to each evaluation pattern.

The performing may include extracting a scenario data by grouping the evaluation patterns upon continued cell grade evaluations for different evaluation patterns.

The performing may include retrieving the summary data based on a received input evaluation item and generating a visualization graph.

The deriving may include performing a check into an ideal point by considering item importance assigned to the design data and the process data, and deriving the improved design proposal.

### BRIEF DESCRIPTION OF THE DRAWINGS

Features will become apparent to those of ordinary skill in the art by describing in detail exemplary embodiments with reference to the attached drawings, in which:

FIG. 1 schematically illustrates an electrode assembly of a secondary battery (e.g., that can be managed according to embodiments of the present disclosure);

FIG. 2 schematically illustrates a configuration of a pouch-type secondary battery (e.g., that can be managed according to embodiments of the present disclosure);

FIG. 3 illustrates a schematic external appearance configuration of a prismatic secondary battery (e.g., that can be managed according to embodiments of the present disclosure);

FIG. 4 is a cross-sectional view of a cylindrical secondary battery (e.g., that can be managed according to embodiments of the present disclosure);

FIG. 5 illustrates a system for managing battery cell data according to one or more embodiments of the present disclosure;

FIG. 6 illustrates a process of deriving a design improvement proposal in the system for managing battery cell data according to embodiments of the present disclosure;

FIG. 7 illustrates a method of managing battery cell data according to embodiments of the present disclosure;

FIG. 8 illustrates a grade evaluation unit according to embodiments of the present disclosure;

FIG. 9 illustrates a grade evaluation process according to embodiments of the present disclosure;

FIG. 10 illustrates the writing of an evaluation pattern and an evaluation scenario according to embodiments of the present disclosure;

FIG. 11 illustrates the handling of an evaluation scenario according to embodiments of the present disclosure;

FIG. 12A-12D illustrate the visualization of data according to embodiments of the present disclosure;

FIG. 13 illustrates the type of battery cell evaluation and the definition item of a summary according to embodiments of the present disclosure;

FIG. 14 is a block diagram illustrating a computer system for implementing a method according to embodiments of the present disclosure;

FIG. 15 is an example view of a secondary battery module in which secondary batteries manufactured according to examples of the present disclosure are arranged;

FIG. 16 is an example view of a secondary battery pack including the secondary battery module illustrated in FIG. 15;

FIG. 17 is a conceptual view of a vehicle including the secondary battery pack illustrated in FIG. 16; and

FIGS. 18A to 18D illustrate a method (with graph) of charging a secondary battery according to embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The terms or words used in the present specification and claims are not to be limitedly interpreted based on their general or ordinary meaning, and should be interpreted as meanings and concepts that are consistent with the technical idea of the present disclosure on the basis of the principle that an inventor can be their own lexicographer to appropriately define concepts of terms to describe their disclosure in the best way.

The example embodiments described in this specification and the configurations shown in the drawings are only some example embodiments of the present disclosure and do not represent all of the aspects of the present disclosure. Accordingly, it should be understood that there may be various equivalents and modifications that can replace or modify one or more example embodiments described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges is within the scope of this disclosure.

References to two compared elements, features, etc. As being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

The terminology used herein is for the purpose of describing example embodiments of the present disclosure and is not intended to limit the present disclosure.

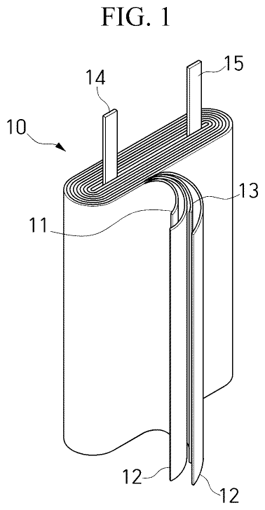

FIG. 1 schematically illustrates an electrode assembly built in a case of a secondary battery.

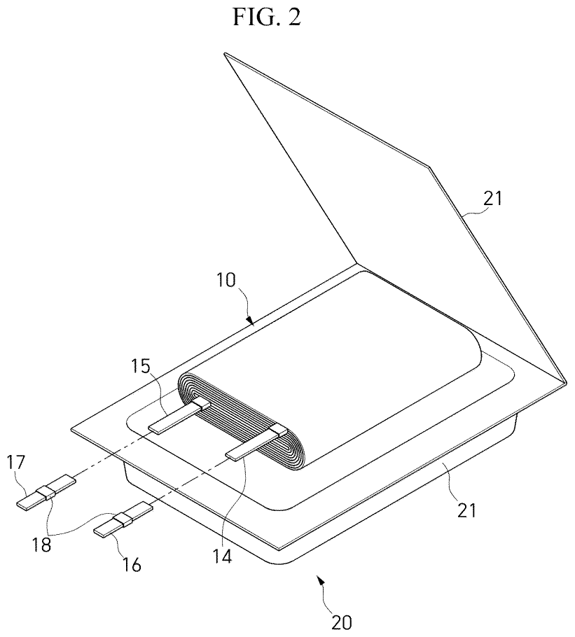

An electrode assembly 10 may be formed by winding or stacking a stack of a first electrode plate 11, a separator 12, and a second electrode plate 13, which are formed as thin plates or films. When the electrode assembly 10 is a wound stack, a winding axis may be parallel to the longitudinal direction (e.g., the Y direction) of the pouch 20 (see FIG. 2), more generally a case. In other example embodiments, the electrode assembly 10 may be a stack type rather than a winding type, and the shape of the electrode assembly 10 may vary. In addition, the electrode assembly 10 may be or include a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case, and the number of electrode assemblies in the case may vary in the examples of the present disclosure. The first electrode plate 11 of the electrode assembly may act as a negative electrode, and the second electrode plate 13 may act as a positive electrode. In other examples, the reverse is also possible.

The first electrode plate 11 may be formed by applying a first electrode active material, such as graphite or carbon, to a first electrode current collector formed of a metal foil, such as copper, a copper alloy, nickel, or a nickel alloy. The first electrode tab 14 may be connected to an external first terminal. In some example embodiments, when the first electrode plate 11 is manufactured, the first electrode tab 14 may be formed by being cut in advance to protrude to one side of the electrode assembly 10, or the first electrode tab 14 may protrude to one side of the electrode assembly 10 more than, e.g., farther than or beyond, the separator 12 without being separately cut.

The second electrode plate 13 may be formed by applying a second electrode active material, such as a transition metal oxide, on a second electrode current collector formed of or including a metal foil, such as aluminum or an aluminum alloy. The second electrode plate 13 may include a second electrode tab 15 (e.g., a second uncoated portion) that is or includes a region to which the second electrode active material is not applied. The second electrode tab 15 may be connected to an external second terminal. In some example embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more than, e.g., farther than or beyond, the separator 12 without being separately cut.

In some example embodiments, the first electrode tab 14 may be located on the left side of the electrode assembly 10, and the second electrode tab 15 may be located on the right side of the electrode assembly 10. In other example embodiments, the first electrode tab 14 and the second electrode tab 15 may be located on one side of the electrode assembly 10 in the same direction (e.g., as shown in FIG. 2).

Here, for convenience of description, the left and right sides are defined according to the electrode assembly 10 as oriented in FIG. 1, and the positions thereof may change when the secondary battery is rotated left and right or up and down.

The separator 12 hinders or substantially prevents a short-circuit between the first electrode plate 11 and the second electrode plate 13 while allowing movement of lithium ions therebetween. The separator 12 may be made of or include, for example, a polyethylene film, a polypropylene film, a polyethylene-polypropylene film, etc.

In some example embodiments, the electrode assembly 10 may be accommodated in the case along with an electrolyte. In the case of a pouch-type secondary battery, an electrode assembly 10 may be accommodated in a pouch made of or including flexible material in the form illustrated in FIG. 1. In the case of a prismatic secondary battery, an electrode assembly 10 may be accommodated in a prismatic metal casing in the form illustrated in FIG. 1.

FIG. 2 schematically illustrates the pouch-type secondary battery.

The pouch-type secondary battery includes an electrode assembly 10 and a pouch 20 that accommodates or contains the electrode assembly 10 therein.

The electrode assembly 10 may be the same as the electrode assembly 10 illustrated in FIG. 1. The first electrode tab 14 and the second electrode tab 15 of the electrode assembly 10 may be electrically connected to respective external first and second terminal leads 16 and 17 by, e.g., welding or other attaching method that preserves conductivity therebetween. At least a portion of each of the first terminal lead 16 and the second terminal lead 17 may be attached or covered with a tab film 18 for insulation from the pouch 20.

The pouch 20 may be sealed by having sealing parts 21 at the edges thereof come into contact with each other while accommodating or containing the electrode assembly 10 therein, in which case the sealing may be achieved with the tab film 18 interposed between the sealing parts 21. The sealing parts 21 of the pouch 20 may be made of or include a thermal fusion material that generally has weak adhesion to metal. Thus, it may be fused to the pouch 20 by interposing the tab film 18, which is thin, between the sealing parts 21.

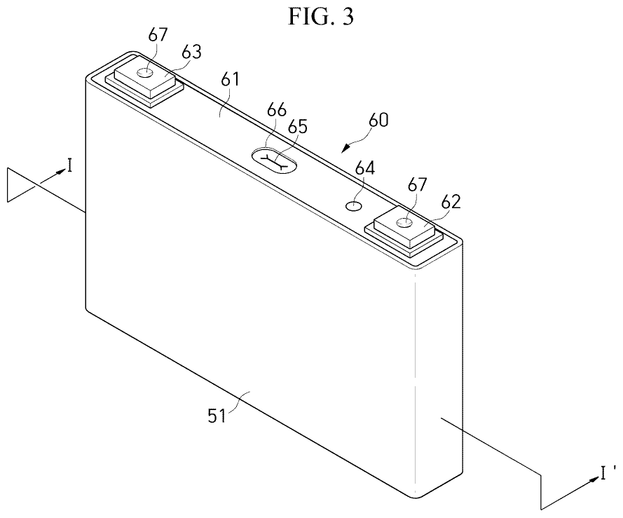

FIG. 3 illustrates a schematic external appearance configuration of a prismatic secondary battery.

A case 59 (prismatic type) defines an overall appearance of the prismatic secondary battery, and may be made of or include a conductive metal, such as aluminum, aluminum alloy, or nickel-plated steel. In addition, the case 59 may provide a space for accommodating or containing the electrode assembly 10 therein.

A cap assembly 60 may include a cap plate 61 that covers an opening of the case 59, and the case 59 and the cap plate 61 may be made of or include a conductive material. A first terminal 63 and a second terminal 62 may be electrically connected to the first electrode tab 14 and the second electrode tab 15 of the electrode assembly 10 illustrated in FIGS. 1 and 2 inside the case 59, and may be installed to protrude outward through the cap plate 61.

The cap plate 61 may be equipped with or include an electrolyte injection port 64 configured to install a sealing plug therein, and a vent 66 formed that includes a notch 65 may be installed. The vent 66 is configured to discharge any gas generated inside the secondary battery.

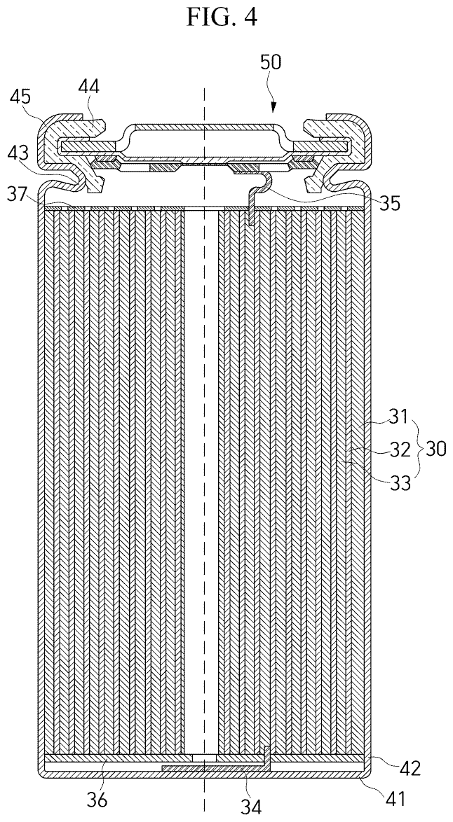

FIG. 4 is a cross-sectional view of a cylindrical secondary battery.

The cylindrical secondary battery includes an electrode assembly 30, a case accommodating the electrode assembly 30 and an electrolyte therein, a cap assembly 50 coupled to an opening of the case to seal the case, and an insulating plate 37 located between the electrode assembly 30 and the cap assembly 50 inside the case.

The electrode assembly 30 may include a separator 32 between a first electrode 33 and a second electrode 31, and the electrode assembly 30 may be wound in a jelly-roll form.

The first electrode 33 may include a first substrate and a first active material layer located on the first substrate. A first lead tab 35 may extend outward from a first uncoated portion of the first substrate where the first active material layer is not located, and may be electrically connected to the cap assembly 50.

The second electrode 31 may include a second substrate and a second active material layer located on the second substrate. A second lead tab 34 may extend outward from a second uncoated portion of the second substrate where the second active material layer is not located, and may be electrically connected to the case. The first lead tab 35 and the second lead tab 34 may extend in opposite directions with respect to each other.

The first electrode 33 may constitute a positive electrode. In this case, the first substrate may be composed of or include, for example, aluminum foil, and the first active material layer may include, for example, a transition metal oxide. The second electrode 31 may constitute a negative electrode. In this case, the second substrate may be composed of or include, for example, copper foil or nickel foil, and the second active material layer may include, for example, graphite.

The separator 32 may reduce or prevent a short-circuit between the first electrode 33 and the second electrode 31 while allowing movement of lithium ions therebetween. The separator 32 may be made of or include, for example, at least one of a polyethylene film, a polypropylene film, a polyethylene-polypropylene film, etc.

The case accommodates or contains the electrode assembly 30 and the electrolyte, and substantially forms the external appearance of the secondary battery together with the cap assembly 50. The case may have a body portion 42, which is substantially cylindrical, and a bottom portion 41 connected to one side of the body portion 42. A beading part 43 deformed inwardly may be formed in the body portion 42, and a crimping part 45 bent inwardly may be formed at an open end of the body portion 42.

The beading part 43 may reduce or prevent movement of the electrode assembly 30 inside the case, and may facilitate seating of a gasket 44 and the cap assembly 50. A crimping part 45 may firmly fix the cap assembly 50 by pressing the edge of the cap assembly 50 against the gasket 44. The case may be formed of or include iron plated with nickel, for example.

The cap assembly 50 may be fixed to the inside of the crimping part 45 through the gasket 44 to seal the case. The cap assembly 50 may include a cap up, a safety vent, a cap down, an insulating member, and a subplate, but may be variously modified.

The cap up may be located at the very top of the cap assembly 50. The cap up may include a terminal portion that protrudes convexly upward and is connected to an external circuit, and an outlet for discharging gas may be located around the terminal portion.

The safety vent may be located below the cap up. The safety vent may include a protrusion that protrudes convexly downward and is connected to the subplate, and at least one notch located around the protrusion.

When gas is generated due to overcharging or abnormal operation of the secondary battery, the protrusion may be deformed upward by pressure and may separate from the subplate, while the safety vent may be cut along the notch. The cut safety vent may hinder or prevent the secondary battery from exploding by discharging gas to the outside.

The cap down may be located below the safety vent. The cap down may be formed with a first opening for exposing the protrusion of the safety vent and a second opening for discharging gas. The insulating member may be located between the safety vent and the cap down to insulate the safety vent and the cap down.

The subplate may be located below the cap down. The subplate may be fixed to a lower surface of the cap down to block the first opening of the cap down, and the protrusion of the safety vent may be fixed to the subplate. The first lead tab 35 pulled out from the electrode assembly 30 may be fixed to the subplate. Accordingly, the cap up, the safety vent, the cap down, and the subplate may be electrically connected to the first electrode 33 of the electrode assembly 30.

The insulating plate 37 may be located below the beading part 43 to be in contact with the electrode assembly 30, and may be provided with a tab opening for pulling out the first lead tab 35. The cap assembly 50, which is electrically connected to the first electrode 33 by the first lead tab 35, may face the electrode assembly 30 with the insulating plate 37 interposed therebetween, and may maintain an insulated state from the electrode assembly 30 by the insulating plate 37. On the other hand, another insulating plate 36 may be included for insulation between the electrode assembly 30 and the bottom portion 41 of the case.

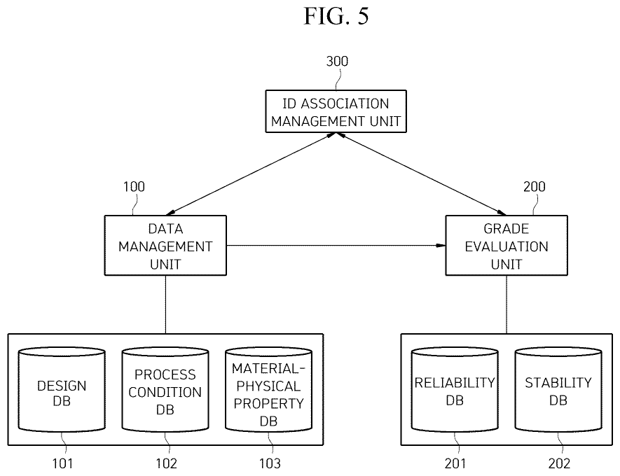

Hereinafter, prior to a description of embodiments of the present disclosure, a problem with a model according to a conventional technology is described. A system for managing battery cell data and a method of managing battery cell data according to embodiments of the present disclosure are described with reference to FIGS. 5 to 13.

Data may be classified even within design data and evaluation data. The design data may include data related to a design, a process, and physical properties. The evaluation data may include data, such as lifespan, storage, DC-IR (e.g., Direct Current Internal Resistance), and heat exposure. A conventional technology has a problem in that there is a confusion of information in a process aspect and a system aspect because big data related to a design, a process, and evaluation are not associated and used.

Furthermore, according to a conventional technology, in the evaluation of a battery cell, there is a problem in that it is difficult to specify a charging or discharging pattern condition based on data that have not been standardized and have a continuous characteristic. According to a conventional technology, there is a problem in that a user has to directly extract data one by one from raw data through continued evaluations upon evaluation.

FIG. 5 illustrates a system for managing battery cell data according to embodiments of the present disclosure.

The system for managing battery cell data according to embodiments of the present disclosure may include a data management unit 100 that manages design and process data, a grade evaluation unit 200 (e.g., grade evaluator) that performs evaluations on a battery cell, and an ID association management unit 300 (e.g., ID associator) that manages the design ID and evaluation ID of the battery cell by associating the design ID and the evaluation ID.

The data management unit 100 is connected to a design database (DB) 101, a process condition DB 102, and a material-physical property DB 103, and may perform the input and output of data and manage design data and process data.

The design DB 101 may store data, such as a thickness, a loading level, and current density.

The process condition DB 102 may store winding and stacking-related condition data.

The material-physical property DB 103 may store CCS (connectivity & cabling system) isolator, NCM-active material (e.g., Lithium Nickel Manganese Cobalt Oxide active material), and electrolyte-related data.

The grade evaluation unit 200 is connected to a reliability DB 201 and a stability DB 202, and may perform inputting and outputting of data.

The reliability DB 201 may store evaluation data, such as lifespan and storage.

The stability DB 202 may store evaluation data, such as heat exposure and overcharge.

The ID association management unit 300 (e.g., ID associator) may manage the design ID of a battery cell, which is generated in a design simulation and management (DSM) way, and the evaluation ID of the battery cell, which is generated in a test data management (TDM) way, by associating the design ID and the evaluation ID.

The grade evaluation unit 200 may identify information of a cell, that is, a target to be evaluated, based on a design ID, and may perform grade evaluation on the battery cell based on the evaluation ID generated based on an evaluation item (or an evaluation type).

In view of the characteristics of a battery cell, although several evaluations are performed on one type of cell, the ID association management unit 300 may perform the input and output of data through communication with the DB in the state in which the design ID and evaluation ID of a battery cell have been associated. Accordingly, it is possible to construct a stable process not having a problem in the confusion and association aspect of information.

According to embodiments of the present disclosure, it is possible to connect the design ID and evaluation ID of a battery cell and data in a product unit and to analyze and evaluate a product because many designs, processes, and evaluation data are representatively managed as key values of the design ID and the evaluation ID in a process of producing and evaluation a battery cell.

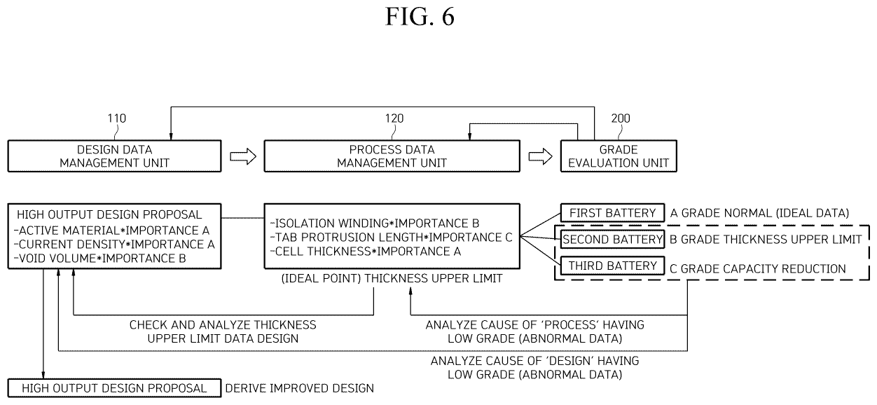

FIG. 6 illustrates a process of deriving a design improvement proposal in the system for managing battery cell data according to embodiments of the present disclosure.

A design data management unit 110 (e.g., design data manager) may manage data for a design proposal for an active material, current density, and a void volume.

A process data management unit 120 (e.g., process data manager) may manage data for isolator winding, a tab protrusion length, and a cell thickness.

The grade evaluation unit 200 (e.g., grade evaluator) may determine grades of first to third batteries, and may determine whether the grade of the battery is a normal grade including ideal data and corresponds to a grade of a preset grade or less according to a thickness upper limit or a capacity reduction.

The grade evaluation unit 200 may provide the design data management unit 110 and the process data management unit 120 with feedback information on a cause analysis-required point (e.g., a root cause analysis) of a battery cell corresponding to a grade of a preset grade or less.

The design data management unit 110 and the process data management unit 120 may individually assign item importance to a data item, that is, a target to be managed.

The item importance may be changed depending on a type (e.g., type of an item) or the type of design.

The process data management unit 120 may request the design data management unit 110 to check and analyze the design of an ideal point based on feedback information. The design data management unit 110 may derive a design improvement proposal.

According to embodiments of the present disclosure, in order to derive a design improvement proposal, data, that is, a target to be associated, may be classified in design, process, and evaluation processes, and different importance may be assigned to related factors (e.g., a thickness upper limit and a capacity reduction) upon design, process, and evaluation.

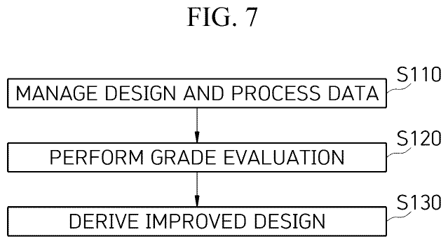

FIG. 7 illustrates a method of managing battery cell data according to embodiments of the present disclosure.

The method of managing battery cell data according to embodiments of the present disclosure may include managing design and process data (S110), performing grade evaluation on a battery cell (S120), and deriving an improved design proposal through feedback for the results of the grade evaluation (S130).

In S110, the design ID of a battery cell may be generated in a design simulation and management (DSM) way. The evaluation ID of the battery cell may be generated in a test data management (TDM) way. The design ID and the evaluation ID may be associated and managed.

In S110, design, process, and evaluation data may be representatively managed as key values of the design ID and the evaluation ID.

In S110, data may be stored in the design DB in which data, such as a thickness, a loading level, and current density are stored, the process condition DB in which winding and stacking-related condition data are stored, and the material-physical property DB in which a CCS isolator, an NCM-active material, and electrolyte-related data are stored. The reliability DB in which evaluation data, such as lifespan and storage, are stored and the stability DB in which evaluation data, such as heat exposure and overcharge, are stored may be managed.

In S120, whether the grade of the battery cell is a normal grade including ideal data and corresponds to a grade of preset grade or less may be determined by performing grade evaluation on a battery cell. In this case, when the grade corresponds to a grade of a preset grade or less related to a thickness upper limit or a capacity reduction, feedback information may be provided.

In S130, a design or process check may be performed on an ideal point by considering item importance that is individually assigned to a data item, that is, a target to be managed. An improved design proposal may be derived.

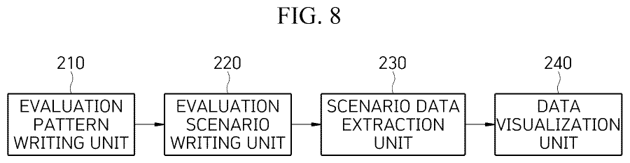

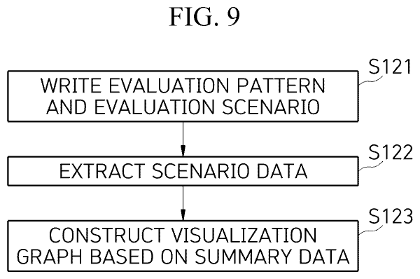

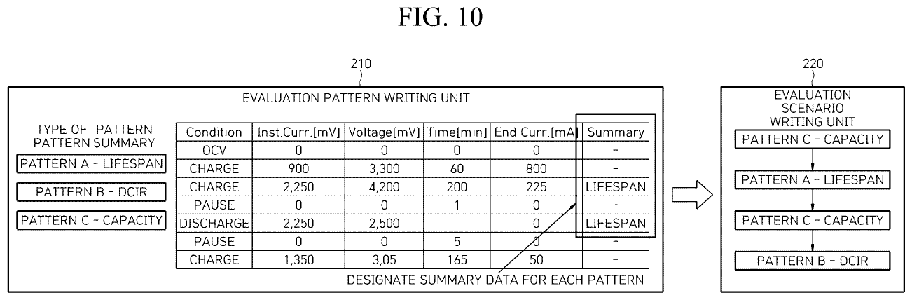

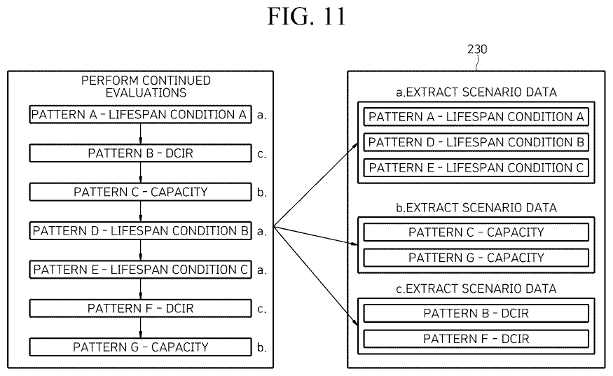

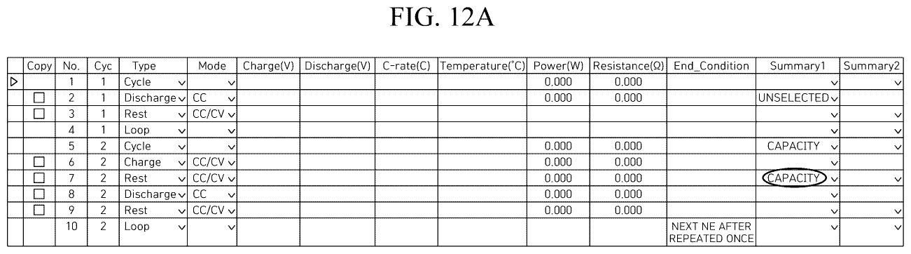

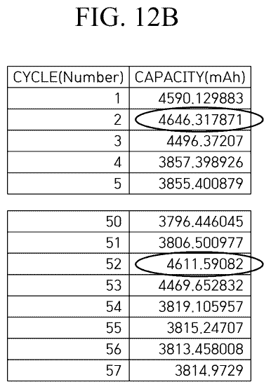

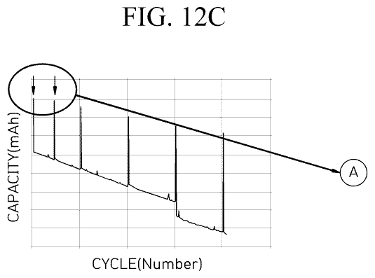

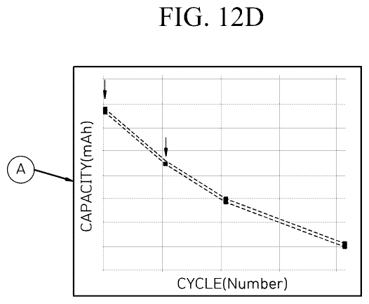

FIG. 8 illustrates the grade evaluation unit according to embodiments of the present disclosure. FIG. 9 illustrates a grade evaluation process according to embodiments of the present disclosure. FIG. 10 illustrates the writing of an evaluation pattern and an evaluation scenario according to embodiments of the present disclosure. FIG. 11 illustrates the handling of an evaluation scenario according to embodiments of the present disclosure. FIGS. 12A to 12D illustrate the visualization of data according to embodiments of the present disclosure.

The grade evaluation unit 200 according to embodiments of the present disclosure may include an evaluation pattern writing unit 210 (e.g., an evaluation pattern writer) that designates pattern summary data according to a pattern type and writes an evaluation pattern, an evaluation scenario writing unit 220 (e.g., an evaluation scenario writer) that writes an evaluation scenario by considering the evaluation pattern, a scenario data extraction unit 230 (e.g., a scenario data extractor) that extracts scenario data for the evaluation pattern in a continued evaluation progress, and a data visualization unit 240 (e.g., data visualizer) that constructs a visualization graph by retrieving summary data based on an evaluation item.

The evaluation pattern writing unit 210 may define key value data by introducing pattern summary data (e.g., lifespan, DCIR, and a capacity) for each type (e.g., A, B, or C) of evaluation pattern.

As an evaluation pattern within an evaluation system is divided and summary data are designated within each pattern, scenario data according to a pattern type can be extracted although continued evaluations are performed.

There is an advantage in that a visualization graph of evaluation data can be constructed without a separate reprocessing process for data because the data are accurately classified.

Performing grade evaluation on a battery cell (S210, FIG. 7) according to embodiments of the present disclosure may include writing an evaluation pattern and an evaluation scenario (S121), extracting scenario data (S122), and constructing a visualization graph based on summary data (S123).

In S121, summary data for each pattern according to a pattern type may be designated, and an evaluation scenario may be written. For example, an evaluation scenario for a pattern C-capacity, pattern A-lifespan, a pattern C-capacity, and pattern B-DCIR may be written (see FIG. 10).

Referring to FIG. 11, continued evaluation may be performed on a pattern A-lifespan condition A, pattern B-DCIR, a pattern C-capacity, a pattern D-lifespan condition B, a pattern E-lifespan condition C, pattern F-DCIR, and a pattern G-capacity. In step S122, scenario data for the pattern A-lifespan condition A, the pattern D-lifespan condition B, and the pattern E-lifespan condition C may be grouped and extracted with respect to a scenario “a”. In S122, scenario data for the pattern C-capacity and the pattern G-capacity may be extracted with respect to a scenario “b”. In S123, pattern B-DCIR and pattern F-DCIR scenario data may be extracted with respect to a scenario “c”.

According to embodiments of the present disclosure, in S122, it is possible to accurately extract data that are substituted into the scenario by using summary data from continued evaluation data.

If the classification of data is impossible, when a graph visualization system is constructed by using raw data, the raw data need to be reprocessed. However, according to embodiments of the present disclosure, there is an advantage in a graph visualization aspect because data substituted into an evaluation scenario can be accurately extracted.

Referring to FIGS. 12A and 12B, for example, in order to indicate lifespan RPT capacity data during lifespan evaluation, a visualization graph may be constructed by inputting summary data to an evaluation pattern and retrieving the summary data based on an evaluation item.

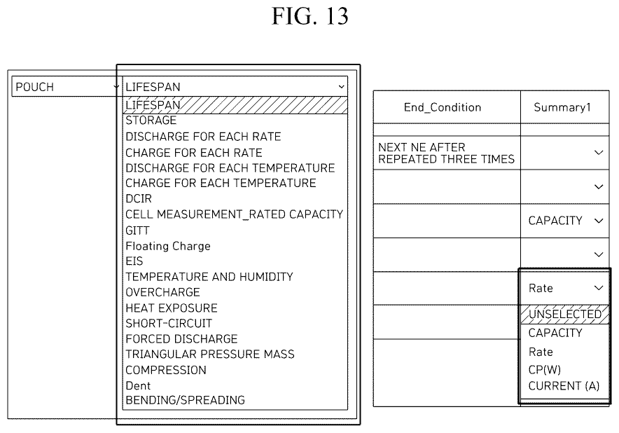

FIG. 13 illustrates the type of battery cell evaluation and the definition item of a summary according to embodiments of the present disclosure.

The type of battery cell evaluation may include lifespan, storage, discharge for each rate, charge for each rate, discharge for each temperature, charge for each temperature, DCIR, cell measurement (e.g., a rated capacity), GITT (galvanostatic intermittent titration technique), floating charge, EIS (electrochemical impedance spectroscopy), a temperature, humidity, overcharge, heat exposure, a short-circuit, forced discharge, a triangular pressure mass, compression, a dent, and bending/spreading.

The summary data may include CP (compact; watt (W)) and current (ampere (A)) in relation to the rate.

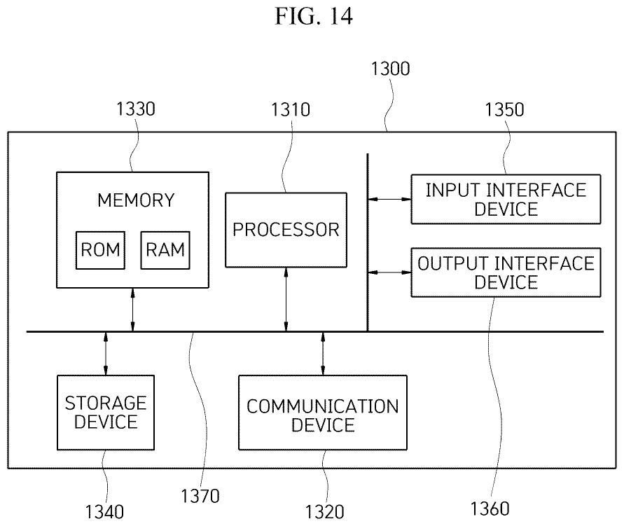

FIG. 14 is a block diagram illustrating a computer system for implementing a method according to an example embodiment of the present disclosure.

Referring to FIG. 14, the computer system 1300 may include at least one of a processor 1310, a memory 1330, an input interface device 1350, an output interface device 1360, and a storage device 1340 communicating with one another through a bus 1370. The computer system 1300 may also include a communication device 1320 coupled to a network. The processor 1310 may be or include a central processing unit (CPU) or a semiconductor device that executes instructions stored in the memory 1330 or in the storage device 1340. The memory 1330 and the storage device 1340 may include various types of volatile or nonvolatile storage media. For example, the memory may include a read-only memory (ROM) and a random access memory (RAM). In example embodiments of the present disclosure, the memory may be located inside or outside the processor, and may be connected to the processor through various known means. The memory is or includes various types of volatile or nonvolatile storage media, and for example, may include a read-only memory (ROM) or a random access memory (RAM).

Accordingly, example embodiments of the present disclosure may be implemented as a method implemented in a computer or a non-transitory computer-readable medium storing computer-executable instructions. In an example embodiment, when executed by the processor, computer-readable instructions may perform a method according to at least one aspect of the present disclosure.

The communication device 1320 may transmit or receive wired signals or wireless signals.

Additionally, the method according to an example embodiment of the present disclosure may be implemented in the form of program instructions that can be executed through various computer means and recorded on a computer-readable medium.

The computer-readable medium may include program instructions, data files, data structures, etc., singly or in combination. The program instructions recorded on the computer-readable medium may be specially designed and configured for the example embodiments of the present disclosure, or may be known and usable by those of ordinary skill in the art of computer software. Computer-readable recording media may include a hardware device configured to store and perform program instructions. For example, the computer-readable recording media may be or include magnetic media such as hard disks, floppy disks, and magnetic tapes, optical media such as CD-ROMs and DVDs, magneto-optical media such as floptical disks, ROM, RAM, flash memory, etc. The program instructions may include not only machine language codes such as that generated by a compiler, but also high-level language codes that can be executed by a computer through an interpreter, etc.

Hereinafter, any material that may be usable for the secondary battery according to examples of the present disclosure will be described.

As the positive electrode active material, a compound capable of reversibly intercalating/deintercalating lithium (e.g., a lithiated intercalation compound) may be used. For example, at least one of a composite oxide of lithium and a metal such as at least one of cobalt, manganese, nickel, and combinations thereof may be used.

The composite oxide may be or include a lithium transition metal composite oxide, and examples thereof may include at least one of a lithium nickel oxide, a lithium cobalt oxide, a lithium manganese oxide, a lithium iron phosphate compound, a cobalt-free nickel-manganese oxide, or a combination thereof.

As an example, a compound represented by at least any one of the following formulas may be used: LiaA1-bXbO₂-cDc (0.90≤a≤1.8, 0≤b≤0.5, 0≤c≤0.05); LiaMn₂-bXbO₄-cDc (0.90≤a≤1.8, 0≤b≤0.5, 0≤c≤0.05); LiaNi1-b-cCobXcO₂-αDα (0.90≤a≤1.8, 0≤b≤0.5, 0≤c≤0.5, 0<α<2); LiaNi1-b-cMnbXcO₂-αDα (0.90≤a≤1.8, 0≤b≤0.5, 0≤c≤0.5, 0<α<2); LiaNibCocL1dGeO₂ (0.90≤a≤1.8, 0≤b≤0.9, 0≤c≤0.5, 0≤d≤0.5, 0≤e≤0.1); LiaNiGbO₂ (0.90≤a≤1.8, 0.001≤b≤0.1); LiaCoGbO2 (0.90≤a≤1.8, 0.001≤b≤0.1); LiaMn1-bGbO₂ (0.90≤a≤1.8, 0.001≤b≤0.1); LiaMn₂GbO₄ (0.90≤a≤1.8, 0.001≤b≤0.1); LiaMn1-gGgPO₄ (0.90≤a≤1.8, 0≤g≤0.5); Li(3-f)Fe₂(PO₄)3 (0≤f≤2); and LiaFePO₄ (0.90≤a≤1.8).

In the above formulas: A is or includes at least Ni, Co, Mn, or a combination thereof; X is or includes at least Al, Ni, Co, Mn, Cr, Fe, Mg, Sr, V, a rare earth element, or a combination thereof; D is or includes at least O, F, S, P, or a combination thereof; G is or includes at least Al, Cr, Mn, Fe, Mg, La, Ce, Sr, V, or a combination thereof; and L1 is or includes at least Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be or include aluminum (Al) but this may vary.

The negative electrode active material may include a material capable of reversibly intercalating/deintercalating at least one of lithium ions, lithium metal, an alloy of lithium metal, a material capable of being doped and undoped with lithium, or a transition metal oxide.

The material capable of reversibly intercalating/deintercalating lithium ions may be or include a carbon negative electrode active material, which may include, for example, at least crystalline carbon, amorphous carbon, or a combination thereof. Examples of the crystalline carbon may include graphite, such as natural graphite or artificial graphite, and examples of the amorphous carbon may include at least one of soft carbon, hard carbon, a pitch carbide, a meso-phase pitch carbide, sintered coke, and the like.

A Si negative electrode active material or a Sn negative electrode active material may be used as the material capable of being doped and undoped with lithium. The Si negative electrode active material may be or include at least silicon, a silicon-carbon composite, SiOₓ (0<x<2), a Si alloy, or a combination thereof.

The silicon-carbon composite may be or include a composite of silicon and amorphous carbon. According to one example embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose compound capable of imparting viscosity may be further included.

As the negative electrode current collector, at least one of copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent may constitute a medium through which ions involved in the electrochemical reaction of the battery can move.

The non-aqueous organic solvent may be or include at least a carbonate, an ester, an ether, a ketone, an alcohol solvent, an aprotic solvent, and may be used alone or in combination of two or more.

Depending on the type of lithium secondary battery, a separator may be present between the first electrode plate (e.g., the negative electrode) and the second electrode plate (e.g., the positive electrode). As the separator, at least polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride polymer or a (meth)acrylic polymer.

The inorganic material may include inorganic particles such as at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but this may vary.

The organic material and the inorganic material may be mixed in one coating layer or may be in the form of a coating layer containing an organic material and a coating layer containing an inorganic material that are laminated on each other.

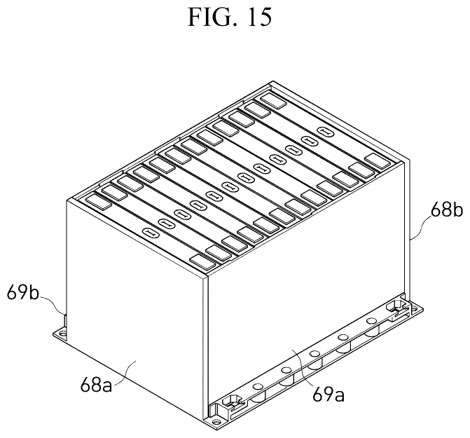

FIG. 15 is an illustration of a secondary battery module in which secondary batteries manufactured according to examples of the present disclosure are arranged. With the increase in secondary battery capacity for driving electric vehicles, and the like, a secondary battery module may be manufactured by arranging and connecting a plurality of secondary battery cells transversely and/or longitudinally. The plurality of secondary batteries may be arranged in a space defined by a pair of facing end plates 68a and 68b and a pair of facing side plates 69a and 69b. The secondary batteries may be designed appropriately in arrangement (direction) and number to obtain desired voltage and current specifications.

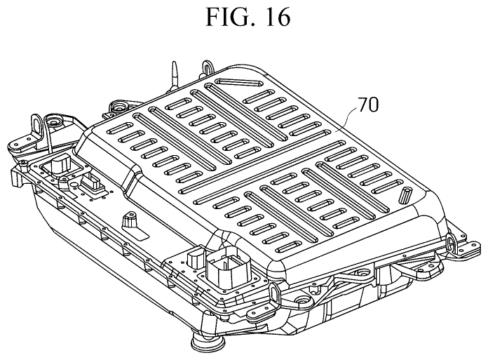

FIG. 16 is an illustration schematically showing the configuration of a battery pack 70 according to example embodiments of the present disclosure. Referring to FIG. 16, a battery pack 70 may include an assembly to which individual batteries are electrically connected, and a pack housing accommodating the same. In the drawings, for convenience of illustration, components including a bus bar, a cooling unit, external terminals for electrically connecting batteries, etc., are not shown.

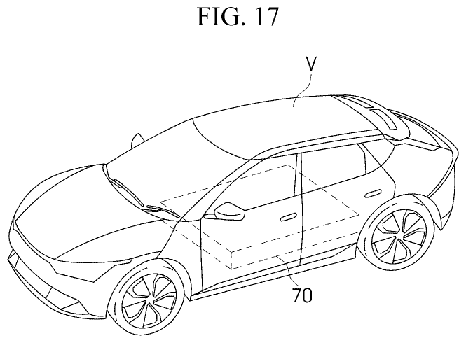

The battery pack 70 may be mounted on (or in) a vehicle. The vehicle may be, for example, an electric vehicle, a hybrid vehicle, a plug-in hybrid vehicle, and the like. The vehicle may be a four-wheeled vehicle or a two-wheeled vehicle but this may vary. FIG. 17 shows a vehicle V which includes the battery pack 70 shown in FIG. 16 on the lower body thereof. The vehicle V may operate by (e.g., may be powered by) receiving power from the battery pack 70.

Effects that can be achieved through the present disclosure are not limited to the above-described effects, and other technical effects not mentioned will be clearly understood by those skilled in the art from the description of the disclosure described herein.

Although the present disclosure has been described above with respect to example embodiments thereof, the present disclosure is not limited thereto. Various modifications and variations can be made thereto by those skilled in the art within the spirit of the present disclosure and the equivalent scope of the appended claims.

A secondary battery can be charged and discharged, for example, according to the following method.

CCCV charging is a charging method in which constant current (CC) charging is performed until the voltage reaches a predetermined level, and then constant voltage (CV) charging is performed until the current flowing becomes small, specifically, until it reaches a termination current value.

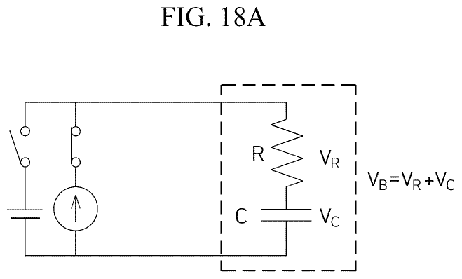

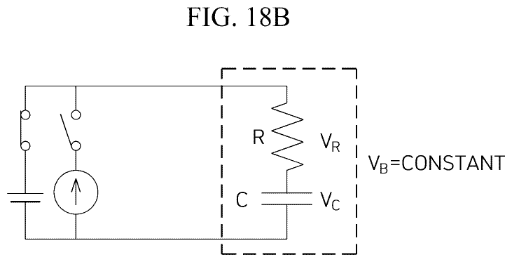

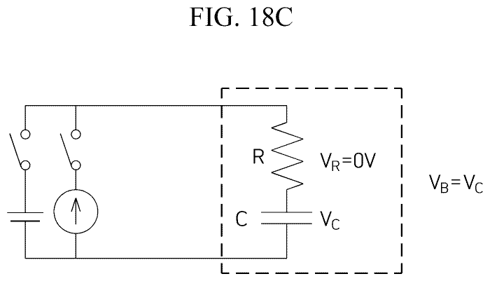

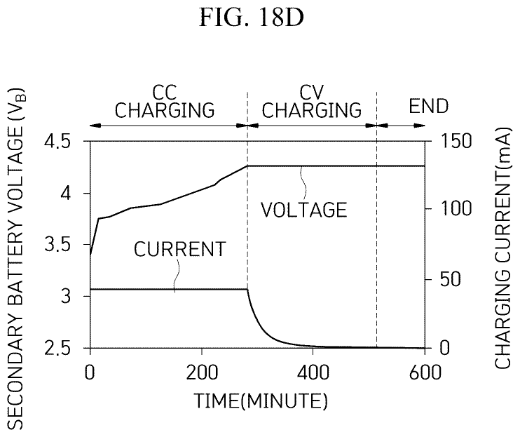

During the CC charging period, as shown in FIG. 18A, the switch of the constant current power source is turned on, and the switch of the constant voltage power source is turned off, allowing a constant current I to flow through the secondary battery. In this period, since the current is constant, the voltage V_{R} applied to the internal resistance R is also constant, according to Ohm's law (V_{R}=R×I). Meanwhile, the voltage VC applied to the capacity C of the secondary battery increases over time. Therefore, the battery voltage V_{B} of the secondary battery also increases over time.

When the secondary battery voltage V_{B} reaches a predetermined voltage, for example, 4.3V, the charging mode is switched from CC charging to CV charging. During CV charging, as shown in FIG. 18B, the switch of the constant voltage power source is turned on and the switch of the constant current power source is turned off, so the battery voltage V_{B} of the secondary battery remains constant. Meanwhile, the voltage V_{C} applied to the capacity C of the secondary battery increases over time. Since V_{B}=V_{R}+V_{C} must be satisfied, the voltage VR applied to the internal resistance R decreases over time. As the voltage VR applied to the internal resistance R decreases, the current I flowing through the secondary battery also decreases according to Ohm's law (V_{R}=R×I).

When the current I flowing through the secondary battery reaches a predetermined current, for example, about 0.01 C, the charging process is terminated. When the CCCV charging is completed, as shown in FIG. 18C, all switches are turned off, and the current I becomes zero. Therefore, the voltage V_{R} applied to the internal resistance R becomes 0V. However, since the voltage V_{R} applied to the internal resistance R has already been sufficiently reduced by the CV charging, even if there is no further voltage drop across the internal resistance R, the secondary battery voltage V_{B} hardly decreases.

FIG. 18D shows an example of the secondary battery voltage V_{B} and the charging current during the CCCV charging process and after the CCCV charging is completed. Even after the CCCV charging is completed, the secondary battery voltage V_{B} hardly decreases.

According to the present disclosure, although a plurality of evaluations is performed on one type of cell in view of battery cell characteristics, the input and storage of data are performed in the state in which design data and evaluation data have been associated. Accordingly, it is possible to construct a process of solving a confusion problem of information and a problem related to the association of information.

According to the present disclosure, it is possible to improve a problem with a method of a user directly extracting data one by one from raw data through continued evaluations and to easily extract and reconstruct data in accordance with each scenario.

Although the present disclosure has been described with reference to limited embodiments and drawings, the disclosure is not limited thereto, and various modifications and alterations can be made by those of ordinary skill in the art without departing from the spirit and scope of the invention as defined by the claims below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A system for managing battery cell data, the system comprising:
a data management unit configured to manage design and process data of a battery cell;
a grade evaluator to grade evaluate the battery cell; and
an ID associator to manage a design ID and an evaluation ID of the battery cell by associating the design ID and the evaluation ID.

2. The system as claimed in claim 1, wherein the data management unit is connected to a design database, a process condition database, and a material-physical property database, the data management unit being configured to perform input and output of data corresponding to the design ID.

3. The system as claimed in claim 1, wherein the grade evaluator is connected to a reliability database and a stability database and performs input and output of data corresponding to the evaluation ID.

4. The system as claimed in claim 1, wherein the ID associator manages the design ID generated in a design simulation and management way and the evaluation ID generated in a test data management way by associating the design ID and the evaluation ID.

5. The system as claimed in claim 4, wherein the ID associator manages design, process, and grade evaluation data as key values of the design ID and the evaluation ID.

6. The system as claimed in claim 1, wherein the grade evaluator:
determines whether a grade of the battery cell is a normal grade comprising ideal data and is an evaluation grade of a preset grade or less based on the evaluation grade, and
classifies a cause analysis-required point, resulting in a classification.

7. The system as claimed in claim 6, wherein the grade evaluator provides feedback information to at least one of a design data manager and a process data manager that are included in the data management unit, based on results of the classification of the cause analysis-required point.

8. The system as claimed in claim 7, wherein the design data manager and the process data manager each assign item importance to a data item that is a target to be managed.

9. The system as claimed in claim 8, wherein the design data manager derives a design improvement proposal by considering the item importance when receiving the feedback information.

10. The system as claimed in claim 1, wherein the grade evaluator comprises:
an evaluation pattern writer to write an evaluation pattern;
an evaluation scenario writer to write an evaluation scenario by considering the evaluation pattern;
a scenario data extraction unit configured to extract a scenario data for the evaluation pattern through a continued evaluation progress; and
a data visualizer to construct a visualization graph by retrieving summary data based on an evaluation item.

11. The system as claimed in claim 10, wherein the evaluation pattern writer designates pattern summary data to each type of pattern.

12. A method of managing battery cell data, the method comprising:
constructing, by a system for managing battery cell data, a management system for design data, process data, and evaluation data;
performing, by the system for managing battery cell data, grade evaluation on a battery cell; and
deriving, by the system for managing battery cell data, an improved design proposal through feedback on results of the grade evaluation.

13. The method as claimed in claim 12, wherein the constructing comprises:
generating a design ID of the battery cell in a design simulation and management way,
generating an evaluation ID of the battery cell in a test data management way, and
managing the design ID and the evaluation ID by associating the design ID and the evaluation ID.

14. The method as claimed in claim 13, wherein the constructing comprises managing design data, process data, and evaluation data as key values of the design ID and the evaluation ID.

15. The method as claimed in claim 12, wherein the constructing comprises managing design data stored in a design database, a process condition database, and a material-physical property database and evaluation data that are stored in a reliability database and a stability database.

16. The method as claimed in claim 12, wherein the performing comprises defining summary data of raw data based on continued evaluations and writing an evaluation scenario.

17. The method as claimed in claim 12, wherein the performing comprises designating a summary data to each evaluation pattern.

18. The method as claimed in claim 17, wherein the performing comprises extracting a scenario data by grouping the evaluation patterns upon continued cell grade evaluations for different evaluation patterns.

19. The method as claimed in claim 18, wherein the performing comprises retrieving the summary data based on a received input evaluation item and generating a visualization graph.

20. The method as claimed in claim 12, wherein the deriving comprises:
performing a check into an ideal point by considering item importance assigned to the design data and the process data, and
deriving the improved design proposal.
